(19) United States
(12) Patent Application Publication
(10) Pub. No.: US 2012/0019564 A1
(43) Pub. Date: Jan. 26, 2012

(54) Methods, Systems, and Media for Presenting Works of Art to a Viewer

(75) Inventors: Jonas Almgren, Brooklyn, NY (US); Alessandra Cirani Almgren, Brooklyn, NY (US); James Cohan, Brooklyn, NY (US); Jane Saks Cohan, Brooklyn, NY (US)

(73) Assignee: MONDAY MORNING PARTNERS LLC, New York, NY (US)

(21) Appl. No.: 13/191,083

(22) Filed: Jul. 26, 2011

Related U.S. Application Data
(60) Provisional application No. 61/367,762, filed on Jul. 26, 2010.

(51) Int. Cl. G06T 11/00

(52) U.S. Cl. 345/667

(57) ABSTRACT

Methods, systems, and media for presenting works of art to a viewer are provided. In accordance with some embodiments, methods for presenting works of art to a viewer are provided, the methods comprising: receiving, at a hardware processor programmed to do so, a plurality of images that each represent a different one of a plurality of physical works of art; receiving, at a hardware processor programmed to do so, size information for each of the plurality of physical works of art; presenting an image representing a physical object on a display; and presenting at least a portion of each of at least some of the plurality of images on the display with sizes scaled according to the relative sizes of the corresponding physical works of art compared to the size of the physical object.

### CROSS REFERENCE TO RELATED APPLICATION

This application claims the benefit of U.S. Provisional Patent Application No. 61/367,762, filed Jul. 26, 2010, which is hereby incorporated by reference herein in its entirety.

### TECHNICAL FIELD

The present invention relates to methods, systems, and media for presenting works of art to a viewer.

### BACKGROUND

Art fairs are a very popular venue for viewing and purchasing artworks by the ordinary consumer of artworks. In a typical art fair, a consumer can walk from gallery booth to gallery booth to view artworks available for purchase.

Unfortunately, however, time and space limit a consumer's ability to attend an art fair. For example, many art fairs are located a long distance from a consumer and/or are only open at times during which the consumer cannot attend.

### SUMMARY

Methods, systems, and media for presenting works of art to a viewer are provided. In accordance with some embodiments, methods for presenting works of art to a viewer are provided, the methods comprising: receiving, at a hardware processor programmed to do so, a plurality of images that each represent a different one of a plurality of physical works of art; receiving, at a hardware processor programmed to do so, size information for each of the plurality of physical works of art; presenting an image representing a physical object on a display; and presenting at least a portion of each of at least some of the plurality of images on the display with sizes scaled according to the relative sizes of the corresponding physical works of art compared to the size of the physical object.

In accordance with some embodiments, systems for presenting works of art to a viewer are provided, the systems comprising: at least one hardware processor that: receives a plurality of images that each represent a different one of a plurality of physical works of art; receiving size information for each of the plurality of physical works of art; presents an image representing a physical object on a display; and presents at least a portion of each of at least some of the plurality of images on the display with sizes scaled according to the relative sizes of the corresponding physical works of art compared to the size of the physical object.

In accordance with some embodiments, computer-readable media containing computer-executable instructions that, when executed by a processor, cause the processor to perform a method for presenting works of art to a viewer are provided, the method comprising: receiving a plurality of images that each represent a different one of a plurality of physical works of art; receiving size information for each of the plurality of physical works of art; presenting an image representing a physical object; and presenting at least a portion of each of at least some of the plurality of images with sizes scaled according to the relative sizes of the corresponding physical works of art compared to the size of the physical object.

### BRIEF DESCRIPTION OF THE DRAWINGS

FIG. 1 illustrates an example of a main entry window to a virtual art fair in accordance with some embodiments.

FIG. 2 illustrates an example of a welcome display and main menu in accordance with some embodiments.

FIG. 3 illustrates an example of a gallery booth view in accordance with some embodiments.

FIG. 4 illustrates an example of a presentation of additional information on a booth in accordance with some embodiments.

FIG. 5 illustrates an example of a virtual booth in accordance with some embodiments.

FIG. 6 illustrates an example of switching from one booth to another in accordance with some embodiments.

FIG. 7 illustrates an example of highlighting of visited booths in accordance with some embodiments.

FIG. 8 illustrates an example of a list view of gallery booths in accordance with some embodiments.

FIG. 9 illustrates an example of a presentation of additional information on a gallery in accordance with some embodiments.

FIG. 10 illustrates an example of various types of works of art that can be presented in a booth in accordance with some embodiments.

FIG. 11 illustrates an example of a zoom view window in accordance with some embodiments.

FIG. 12 illustrates an example of a video clip presentation in accordance with some embodiments.

FIG. 13 illustrates an example of an advice note presentation in accordance with some embodiments.

FIG. 14 illustrates an example of a chat menu that can be used to select a chat participant in accordance with some embodiments.

FIG. 15 illustrates an example of a chat menu for viewing incoming chat requests in accordance with some embodiments.

FIG. 16 illustrates an example of a chat window in accordance with some embodiments.

FIG. 17 illustrates an example of a private room in accordance with some embodiments.

FIG. 18 illustrates an example of a mechanism for configuring a private room in accordance with some embodiments.

FIG. 19 illustrates an example of a video chat in accordance with some

FIG. 20 illustrates an example of a list of private rooms in accordance with some embodiments.

FIG. 21 illustrates an example of an artwork upload interface in accordance with some embodiments.

FIG. 22 illustrates an example of an interface for managing favorites and tours in accordance with some embodiments.

FIG. 23 illustrates an example of hardware that can be used in accordance with some embodiments.

### DETAILED DESCRIPTION

Systems, methods, and media for selling works of art are provided.

In accordance with some embodiments, a virtual art fair is provided. In this virtual art fair, one or more virtual gallery booths can be provided. In each gallery booth, one or more works of art can be presented, along with any suitable information, so that the works can be sold. In some embodiments, a gallery booth attendant can communicate with a gallery booth visitor to aid them in their purchasing decision making. The virtual art fair may be open for a limited period, or limited periods, of time.

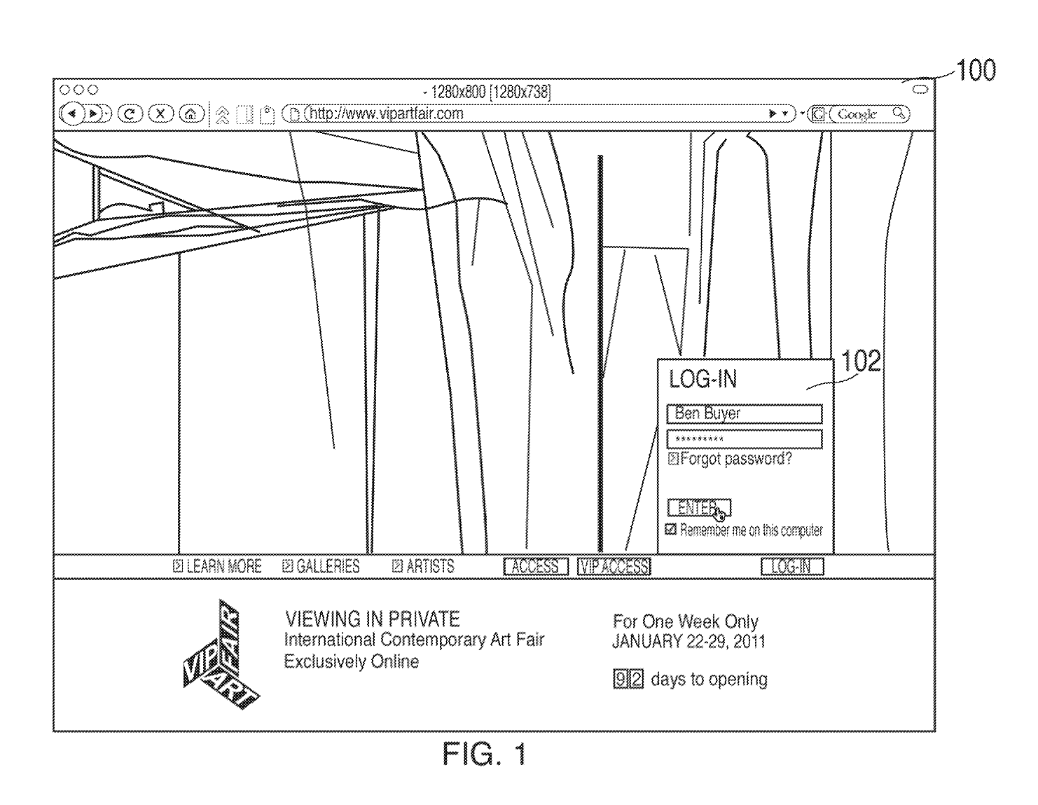

Turning to FIG. 1, an example of a main entry window 100 to a virtual art fair is shown. As illustrated, a user can log-in to the art fair using a log-in window 102. In some embodiments, logging-in is not required, such as when members of the general public visit the art fair. In some embodiments, certain people may be given exclusive access to the art fair during a period before, during, or after one or more times when the public has access to the art fair.

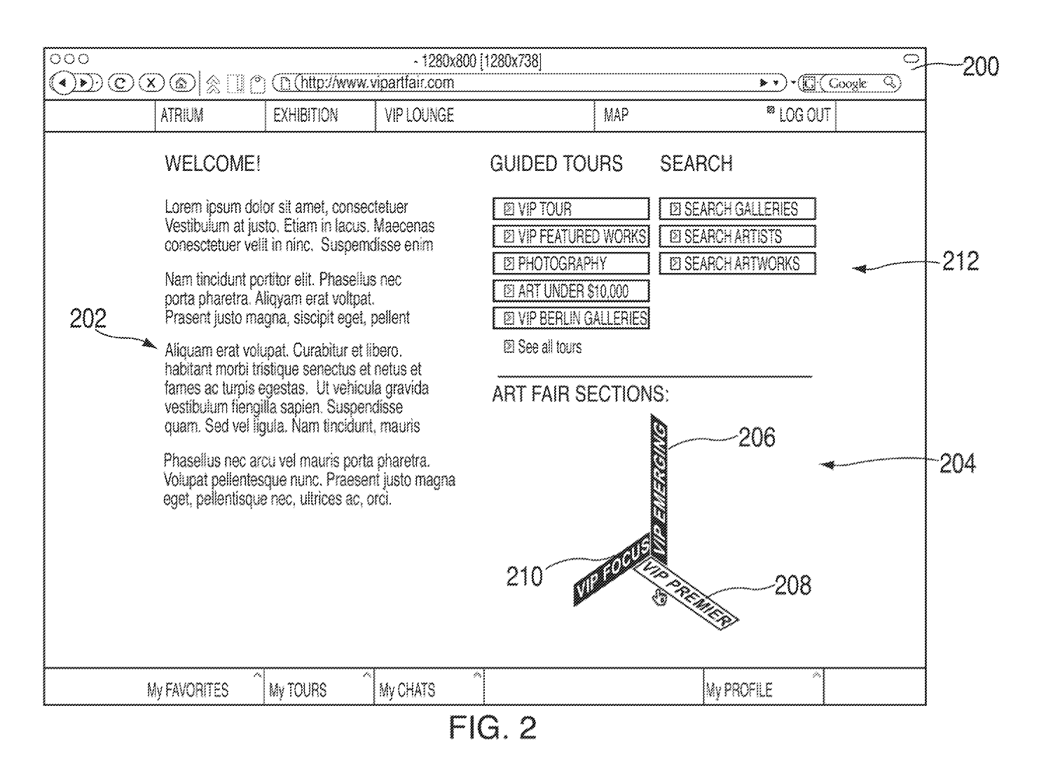

After a user enters the art fair, the user may first be presented with a welcome display 200 as shown in FIG. 2. As illustrated, the welcome display may present introductory text 202, a menu 212, and a graphical representation of the art fair 204. The introductory text 202 may be any suitable text to introduce the user to the art fair. The menu 212 may contain options to take a tour of the art fair, to view featured works, to see photographs, to see art for sale under a specified price (e.g., $10,000), the view certain gallery booths, to search participating galleries, to search specific artists, to search specific works of art, to enter an exhibition, to enter a lounge, to view a map of the virtual art fair, to view favorite items (e.g., works of art, gallery booths, etc.), to view tours, to view chat sessions, to view/edit the user's profile, etc. The graphical representation of the art fair 204 may be any suitable graphical object representing the virtual layout of the art fair. As illustrated, in some embodiments, a graphical object may have three bars 206, 208, and 210, wherein each bar represents a portion of the virtual art fair. For example, bar 206 can be used to represent a portion of the art fair containing emerging galleries (e.g., galleries in business less than five years and having booths containing a medium number of works of art), bar 208 can be used to represent a portion of the art fair containing premier galleries (e.g., galleries in business more than five years and having booths containing a large number of works of art), and bar 210 can be used to represent a portion of the art fair containing focus galleries (e.g., galleries only contain a single artist and a medium number of works of art). If a user clicks-on a portion of the graphical object, a corresponding portion of the art fair may be displayed.

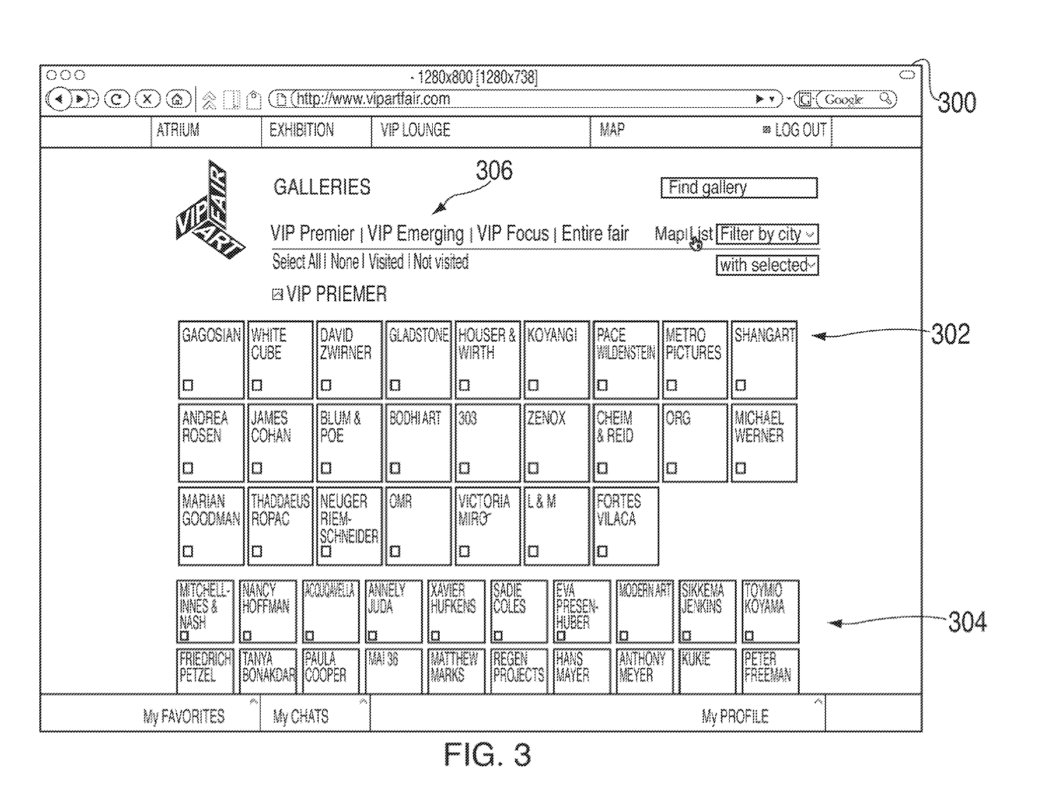

Upon entering a portion of the art fair (e.g., by clicking on one of bars 206, 208, or 210), a gallery booth view 300 may be presented as shown in FIG. 3. As illustrated, view 300 can display booths 302 and 304 for various galleries. These booths can be represented by blocks having sizes corresponding to the number of works of art in each booth, or class of booth. For example, booths 302 are represented by bigger blocks than booths 304 to illustrate that they contain more works of art. Booths 302 and 304 also indicate the name of the gallery corresponding to the booth. A user can use links 306 to jump to a particular portion of the art fair by gallery type (e.g., premier, emerging, focus, and all). A user can also select different booths (e.g., based on whether the booth was visited or not, by selecting all, by clicking on specific ones, etc.) in order to configure a list of booths to be visited. In some embodiments, a user can display the booths in a list format additionally or alternatively to displaying them in a map format. In some embodiments, booths can be filtered by city. In some embodiments, other operations can be performed on selected gallery booths. For example, using a drop down menu, an operation, such as creating a tour for one or more selected gallery booths, marking one or more selected booths as visited or not visited, etc., can be performed.

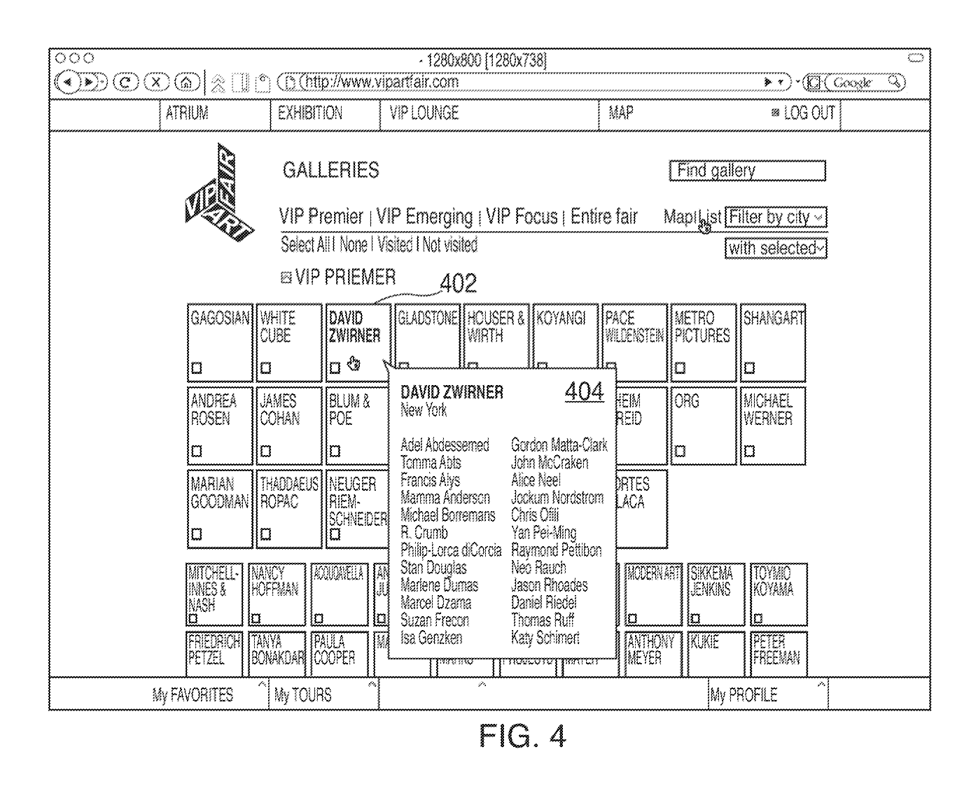

As shown in FIG. 4, upon hovering a mouse pointer over a gallery booth 402, a user may be presented with more information 404 on the booth, such as the name of the corresponding gallery, the city of the physical location of the gallery, and artists shown in the gallery.

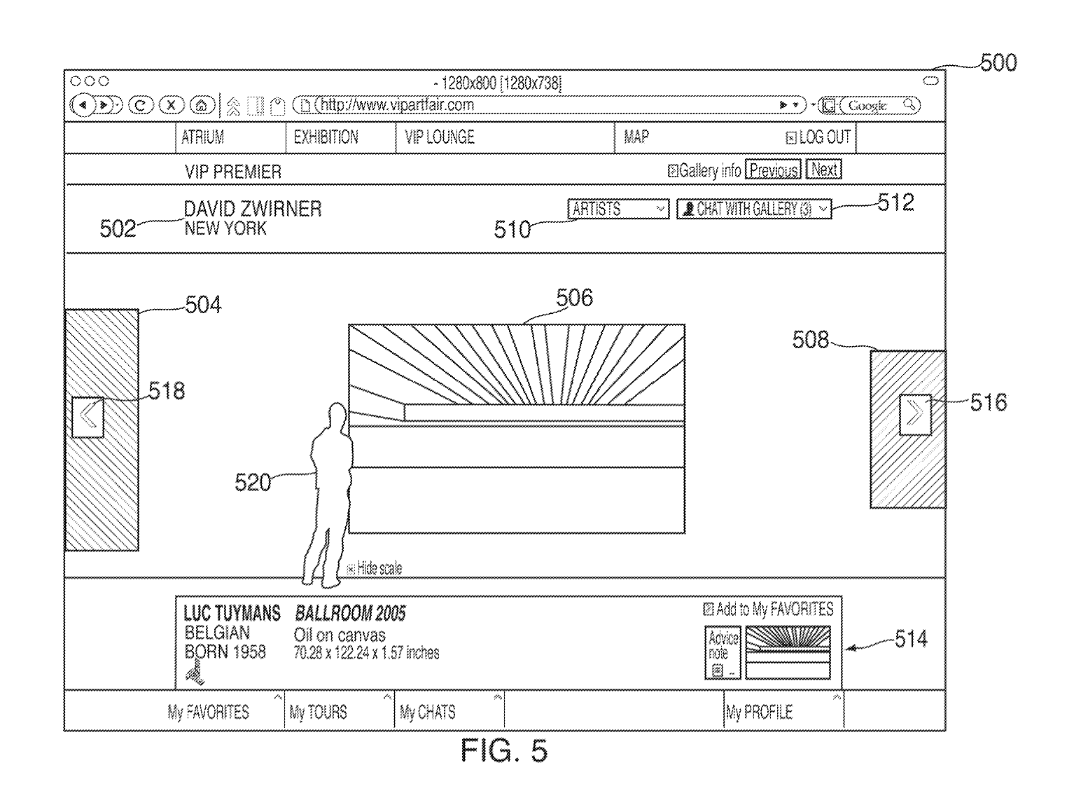

Upon clicking on a gallery booth 402, a user may be taken to a corresponding virtual booth 500 as illustrated in FIG. 5. As shown, the virtual booth may include the name and city 502 of the corresponding gallery, works of art 504, 506, and 508, an artist selection menu 510, a chat initiation button 512, and an artwork information window 514.

As illustrated, works of art 504, 506, and 508 can be arranged in any suitable configuration by gallery corresponding to the booth. A user can switch between works using forward and back buttons 516 and 518, respectively.

In some embodiments, works can be presented in a manner that shows the scale of the works. For example, in some embodiments, a shadow of a person 520 can be used to illustrate the scale of the work compared to a viewer. In some embodiments, this shadow may be customized to represent the gender, height, etc. of the user based on information in the user's profile. As another example, in some embodiments, multiple works can be displayed in scale size relative to each other, the shadow figure, and the wall they are presented on (for example, based on a 10 foot wall, which is the standard height for walls at many art fairs). In some embodiments, works of art that are too large to fit on a represented wall, or too small to be clearly visible, can be indicated as being displayed “out of size” to represent that they are not to scale to a shadow figure, a represented wall, other works, etc. Additionally or alternatively, in some embodiments, a shadow figure may be shown in relative size to the “out of size” artwork, while other works are not.

When a work is being presented in the position of work 506 in FIG. 5, information for that work can be presented in window 514. This window can include any suitable information. For example, the information can include the name, citizenship, and year of birth of the artist corresponding to the work, the name, year, materials, and size of the work. This window can also include one or more thumbnail images corresponding to different views of the artwork. In some embodiments, links may be provided to download a PDF file containing the displayed information (and/or any other suitable information) and to add the work to a list of favorite works.

Artist menu 510 can be used to view a list of artists in the booth and view works corresponding to a selected one or more of those artists. Chat initiation button 512 can be used to initiate a chat regarding the booth, as described further below.

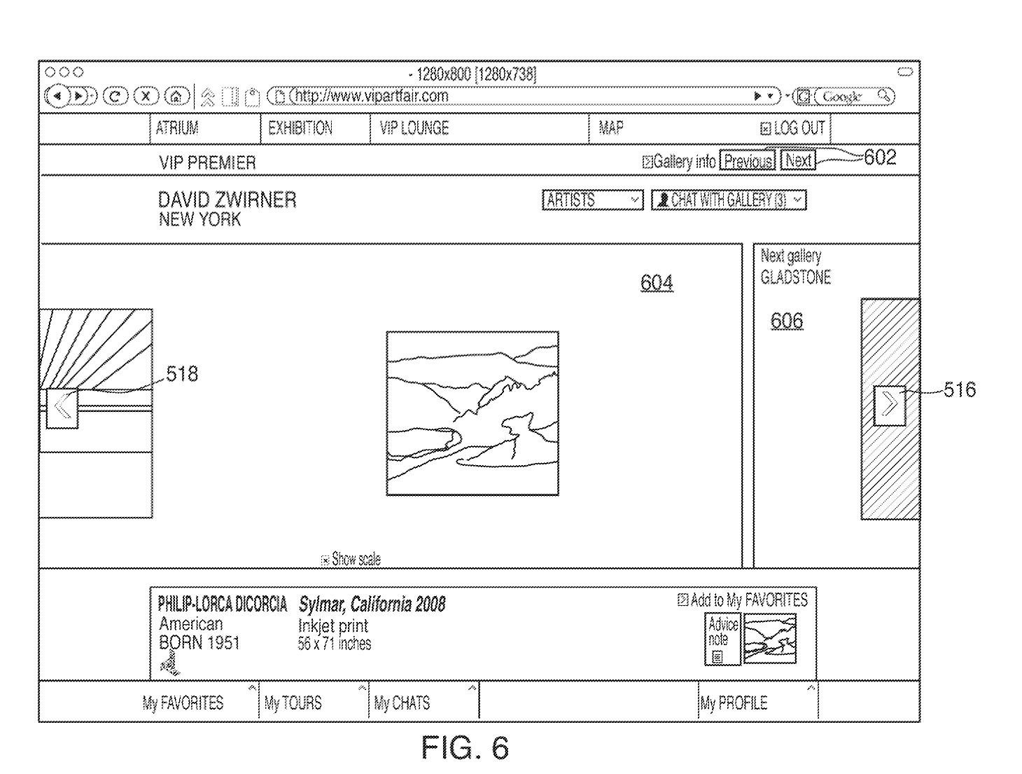

As shown in FIG. 6, previous and next buttons 602 can be used to switch from one gallery booth to an adjacent gallery booth (e.g., adjacent in a virtual art fair map or adjacent in a list of gallery booths to visit). Additionally or alternatively, two adjacent gallery booths 604 and 606 may be presented graphically and the user can switch from one gallery to the next using forward and back buttons 516 and 518.

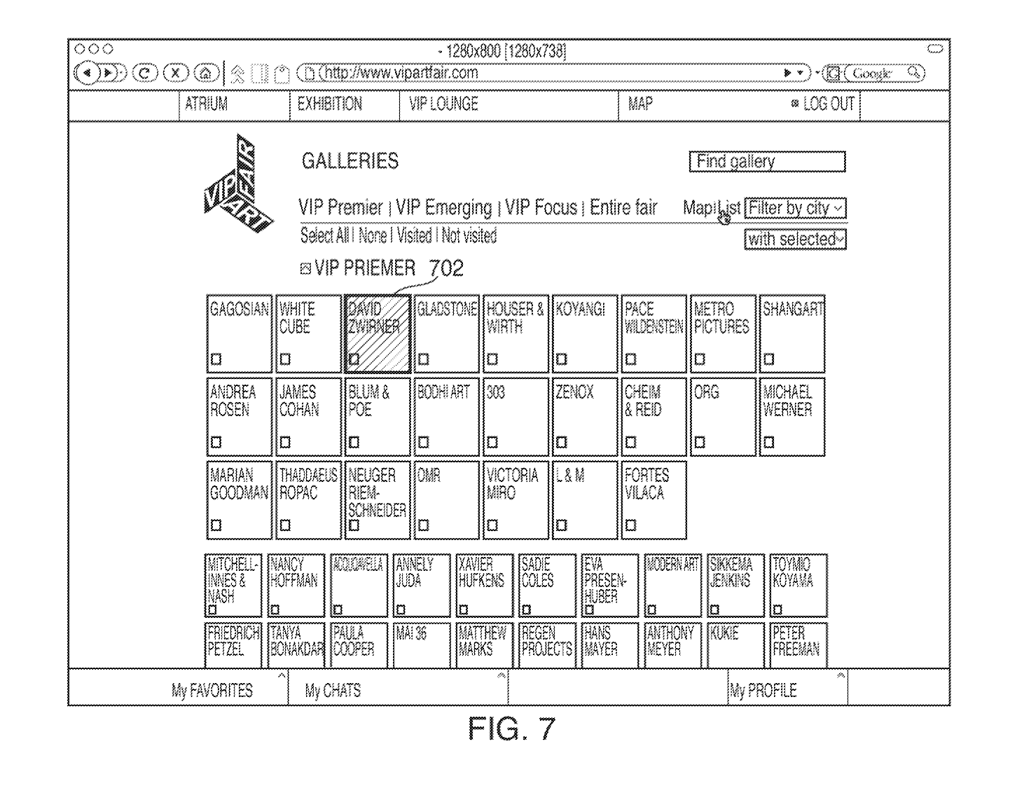

As illustrated in FIG. 7, gallery booths 702 that have been visited by a user can subsequently be highlighted to let the user know that he/she has been to that virtual booth.

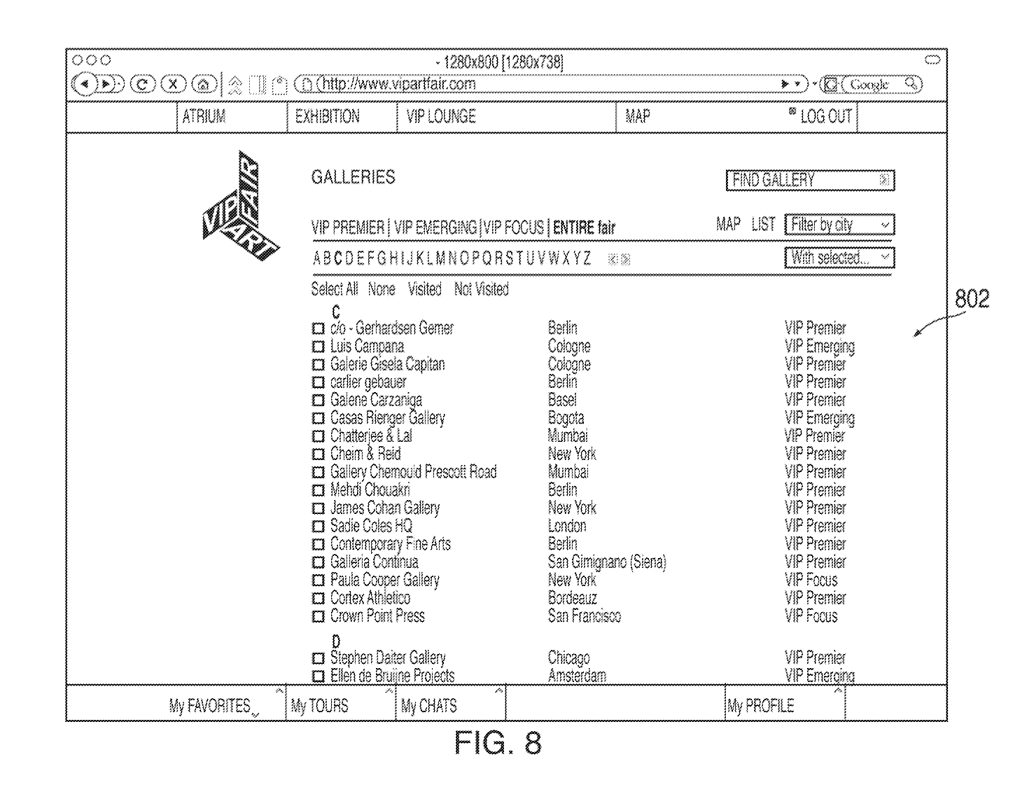

FIG. 8 illustrates an example of a list view of gallery booths that can be displayed in some embodiments. As shown, the list view displays the name of the gallery corresponding to a booth, the city of the gallery, and the type of gallery booth. The list can initially be sorted alphabetically, and in some embodiments, the user can change the sort order of the list to e.g. region and city of the gallery. Any additional or alternative information (such as the number of works in the booth, the number of artists in a booth, etc.) can be displayed. In some embodiments, gallery booths in the list that have been visited may be highlighted.

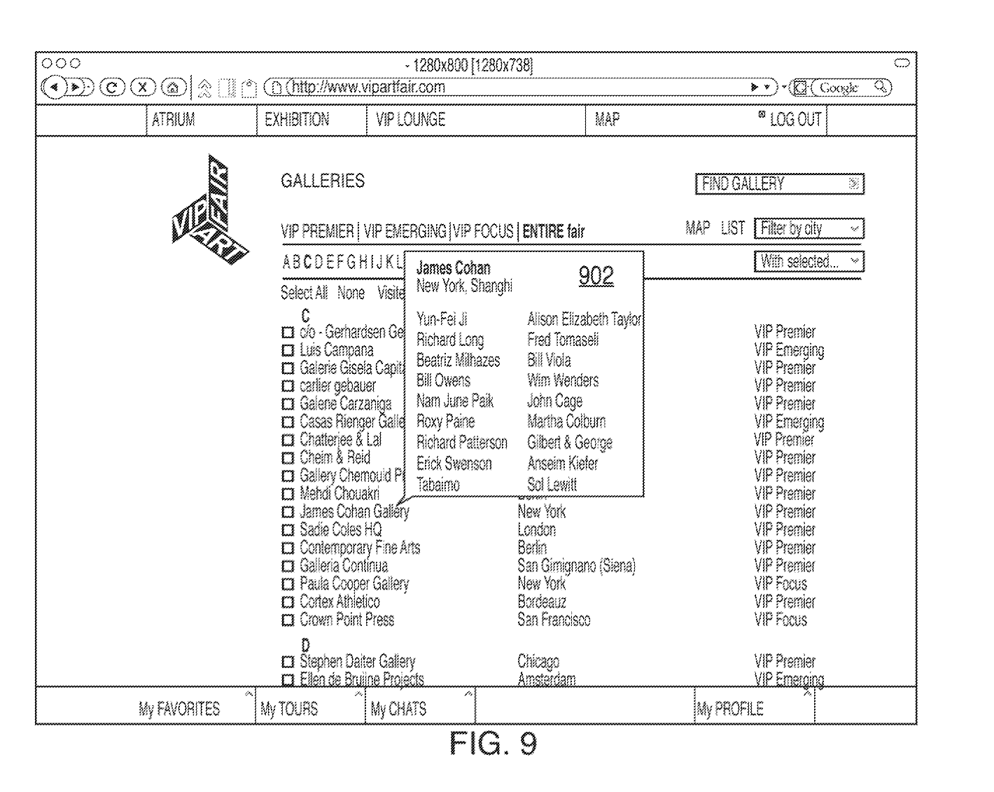

As illustrated in FIG. 9, when a user hovers over a gallery name, additional information 902 for the gallery, such as the names of other physical locations for the gallery and artists associated with the gallery, can be displayed.

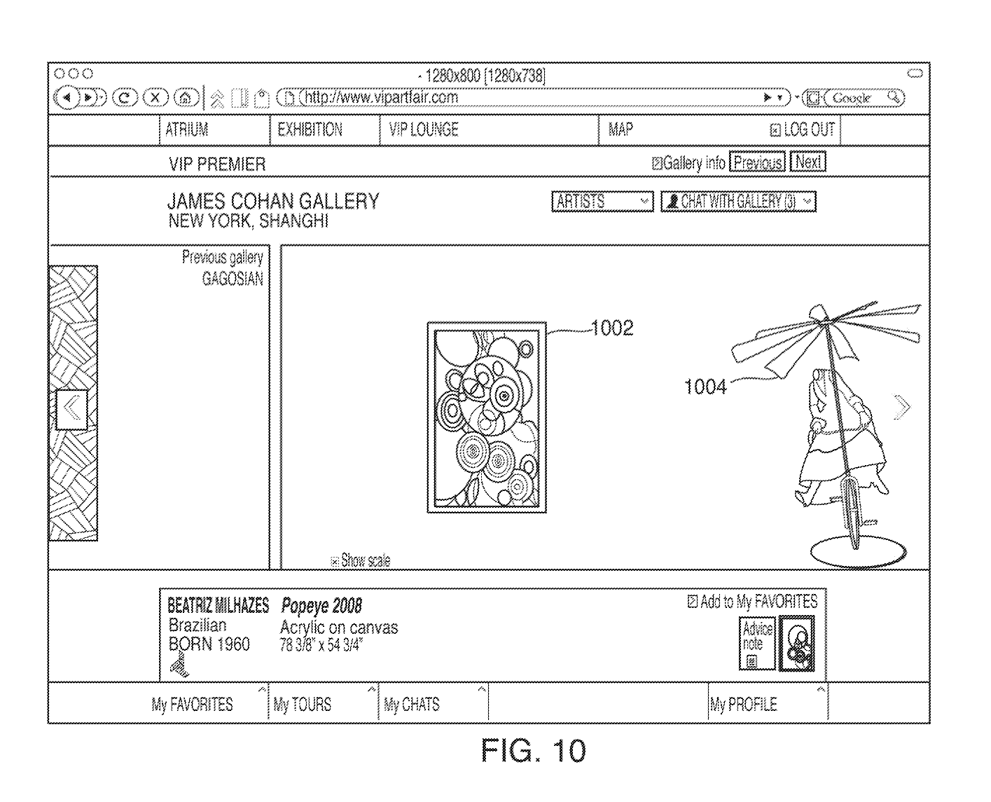

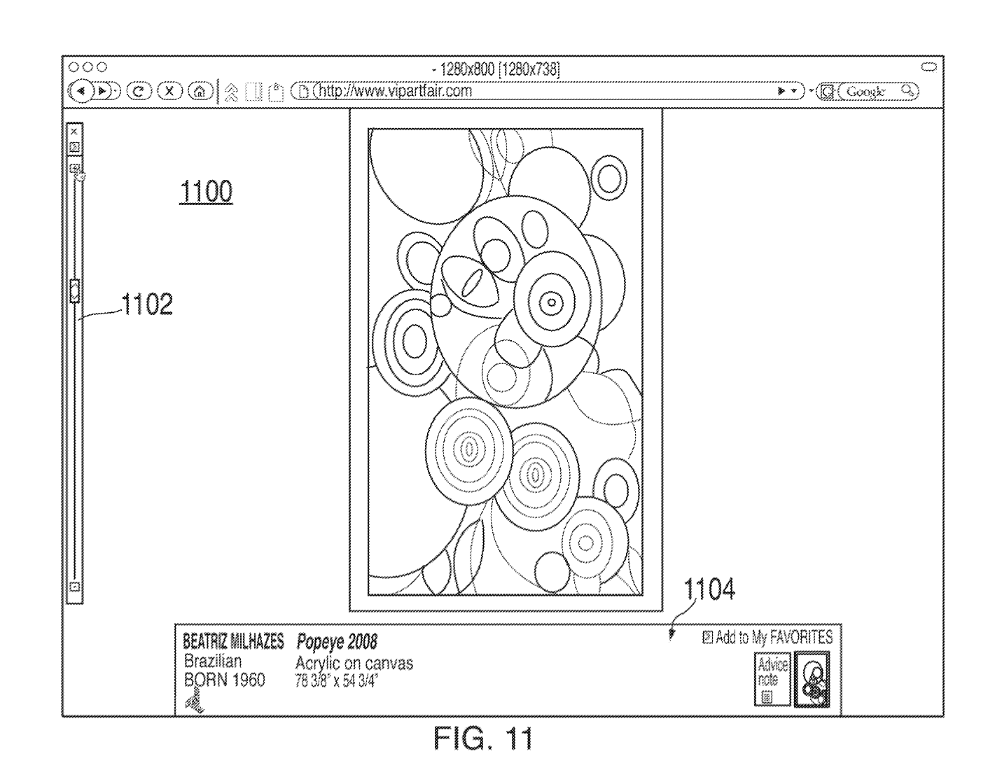

As illustrated in FIG. 10, any suitable types of works of art can be presented in some embodiments. For example, as shown, paintings 1002 and sculptures 1004 can be presented in a virtual booth. When a user clicks on a work 1002, the user may be presented with a zoom window 1100 as shown in FIG. 11. The window may permit a user to zoom in and out on a work to view more detail using a zoom bar 1102. In some embodiments, multiple thumbnail images of different views of an artwork can be presented in window 1104 and the user may be able to click on a given thumbnail image to view a corresponding image in the zoom window.

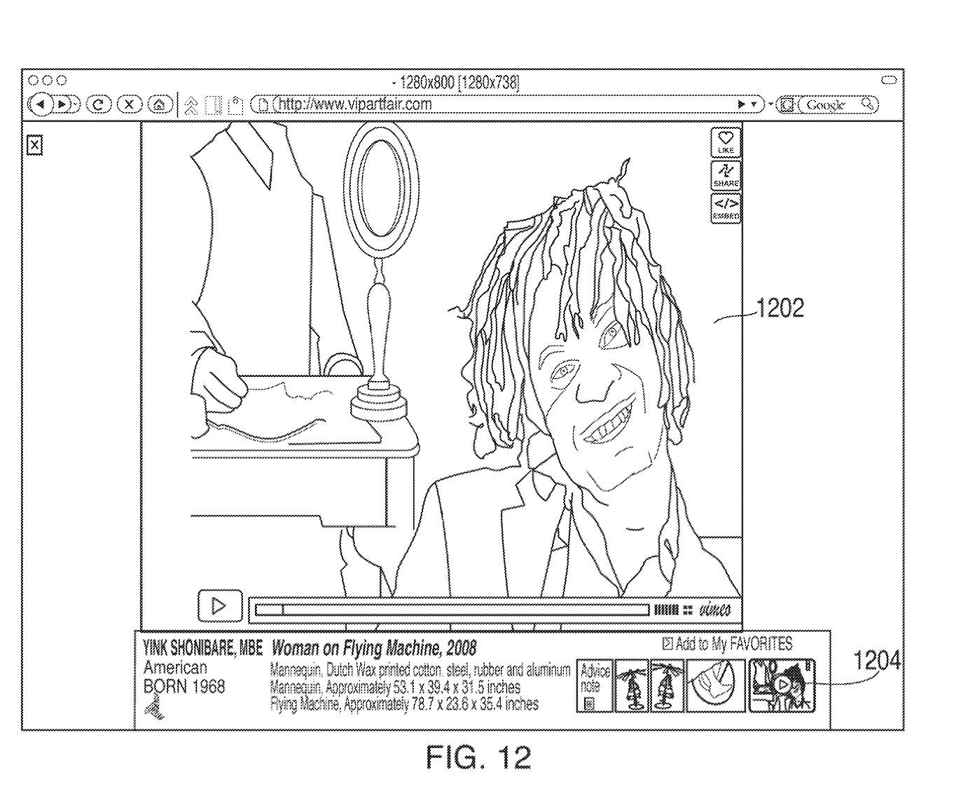

In some embodiments, a user may be able to view a video clip 1202 corresponding to a work, an artist, a gallery, etc. by clicking on a video icon 1204 as shown in FIG. 12.

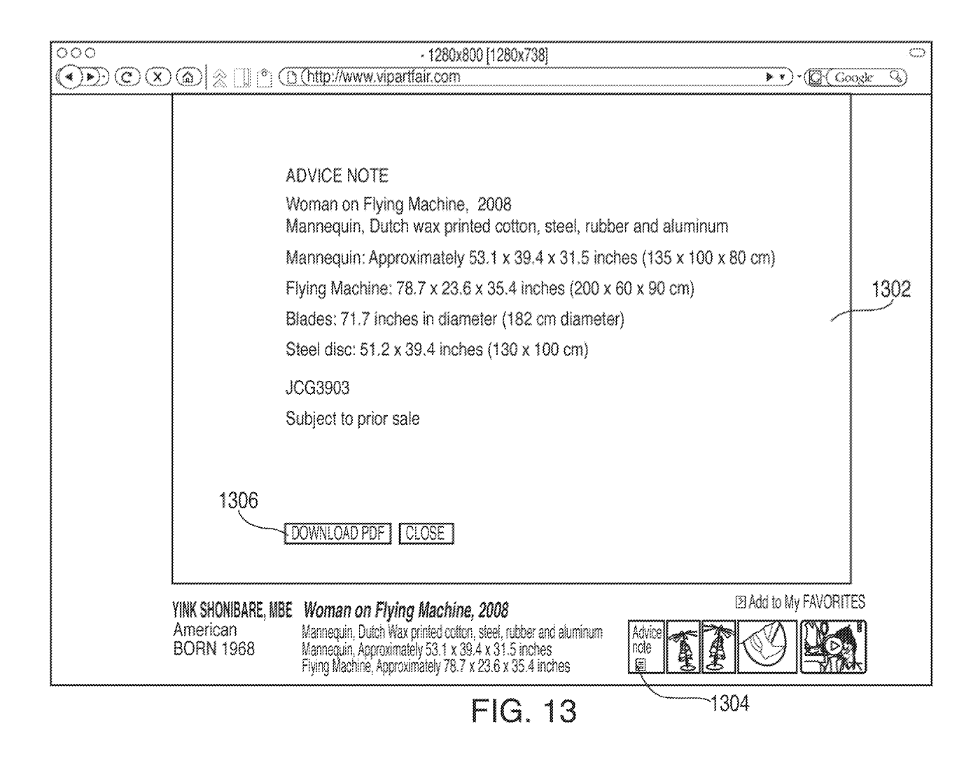

As shown in FIG. 13, in some embodiments, a user can view an advice note 1302 by clicking on an advice note icon 1304. The user can also download a PDF file containing the advice note in some embodiments by clicking on a download PDF button 1306.

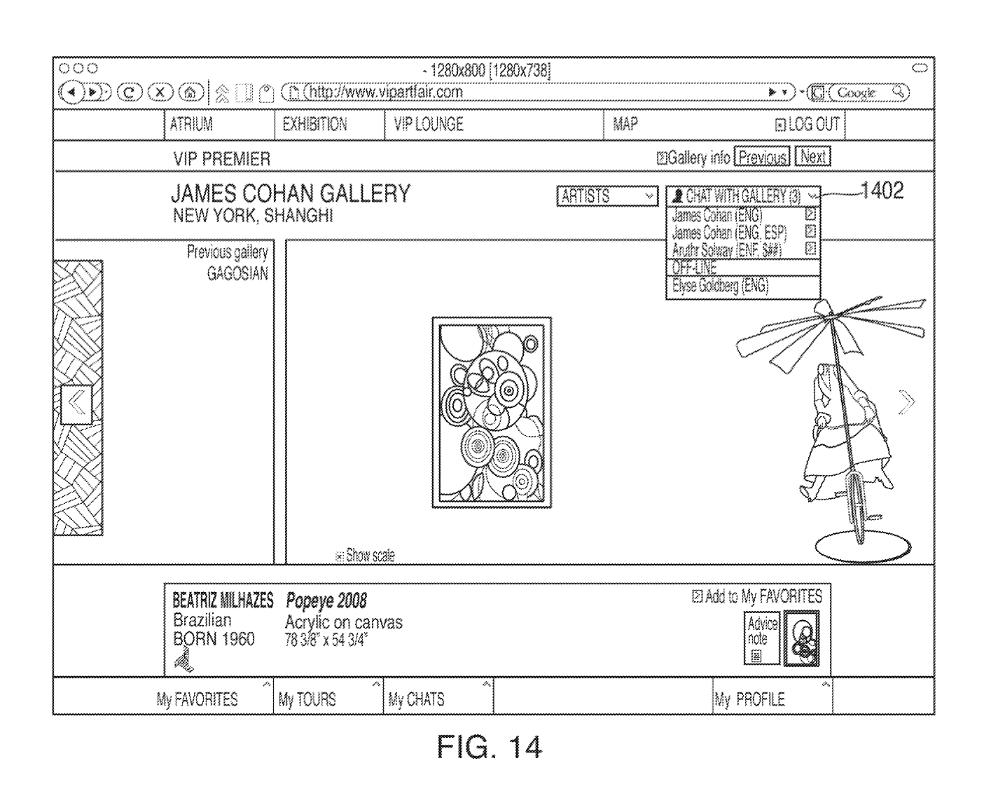

If a user desires to chat with someone regarding a work, a booth, a gallery, etc., the user can use chat menu 1402 to select a chat participant as shown in FIG. 14. As illustrated, the names and languages for various chat participants can be displayed in menu 1402. Chat participants can be any suitable parties, such as gallery owners or employees, artists, customers, etc. In some embodiments, the chat menu can highlight which participants are currently online, and can include information related to how “busy” a particular participant is (e.g., in terms of current number of active chats, by giving an estimated wait time until the participant is available to respond to a new chat request, etc.).

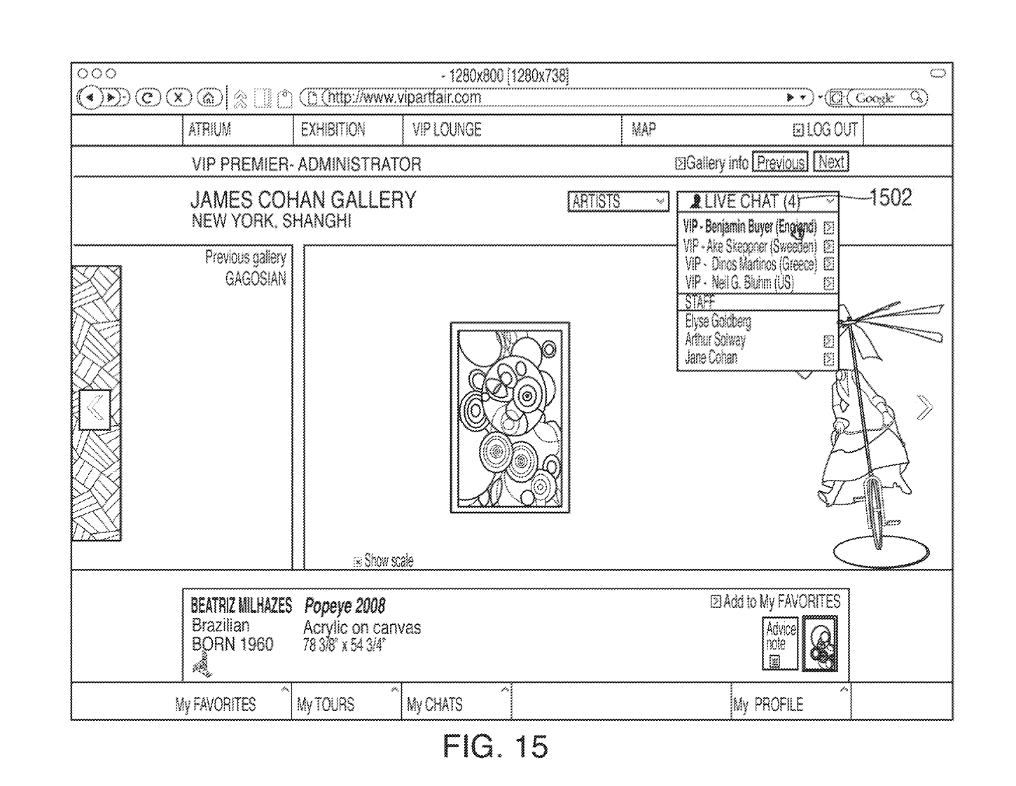

As shown in FIG. 15, a chat participant can view incoming chat requests using a chat menu 1502 in some embodiments. The participant can view from whom a chat request is coming, their status (e.g., VIP, PRESS, or Paying Visitor), country of residence, and more details by clicking on an indicated name. The participant can use this information to prioritize in which order to respond to incoming chat requests.

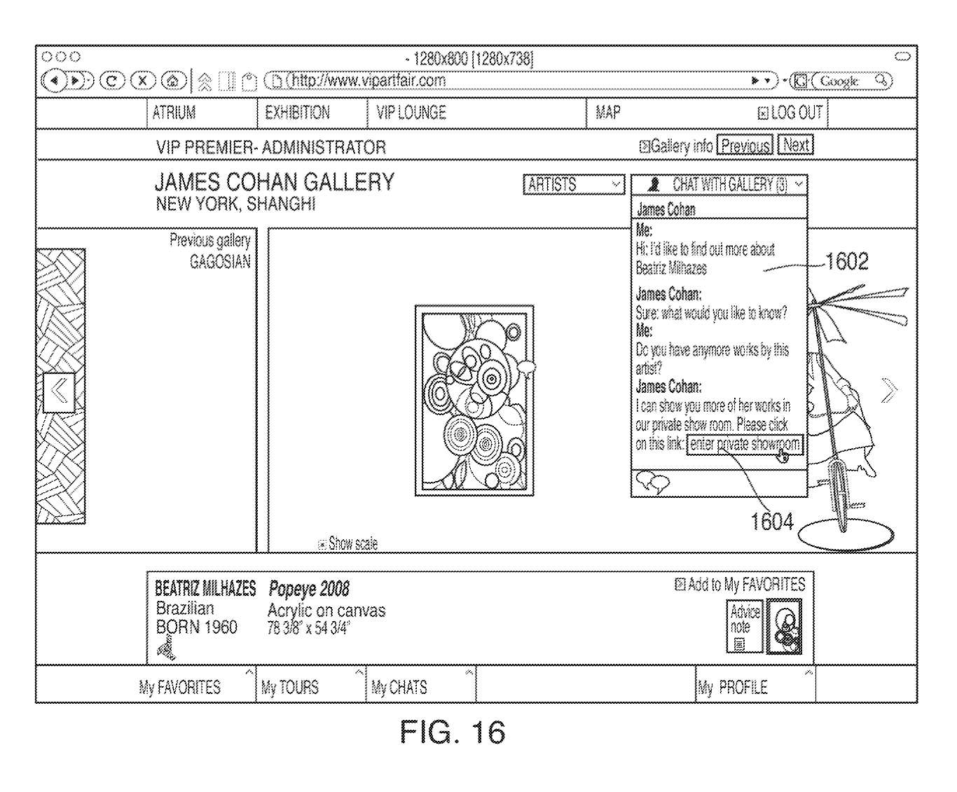

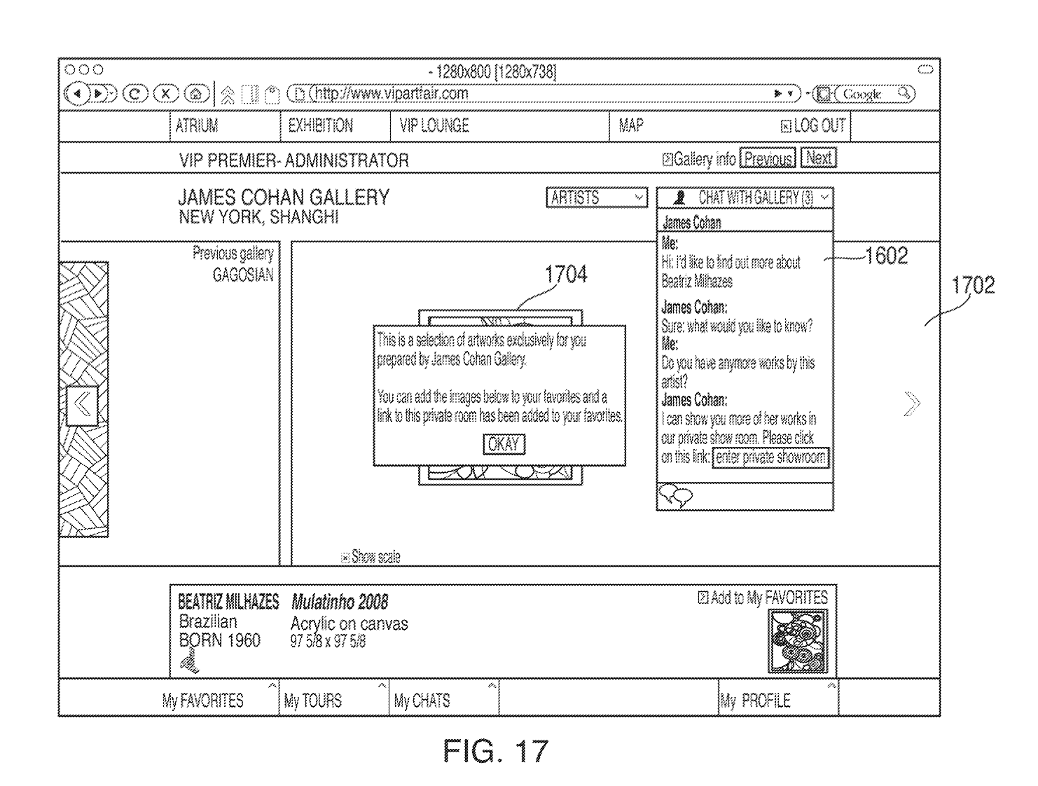

When a participant initiates a chat session using chat menu 1502 of FIG. 15, a user can then be presented with a chat window 1602 as shown in FIG. 16. If invited by the participant, a user can elect to enter a private room with the other chat participant by clicking on a private room button 1604. FIG. 17 shows an example of a private room 1702. In this room, the previous chat window 1602 is maintained and works of art 1704 selected for the user by a gallery owner or employee can be presented.

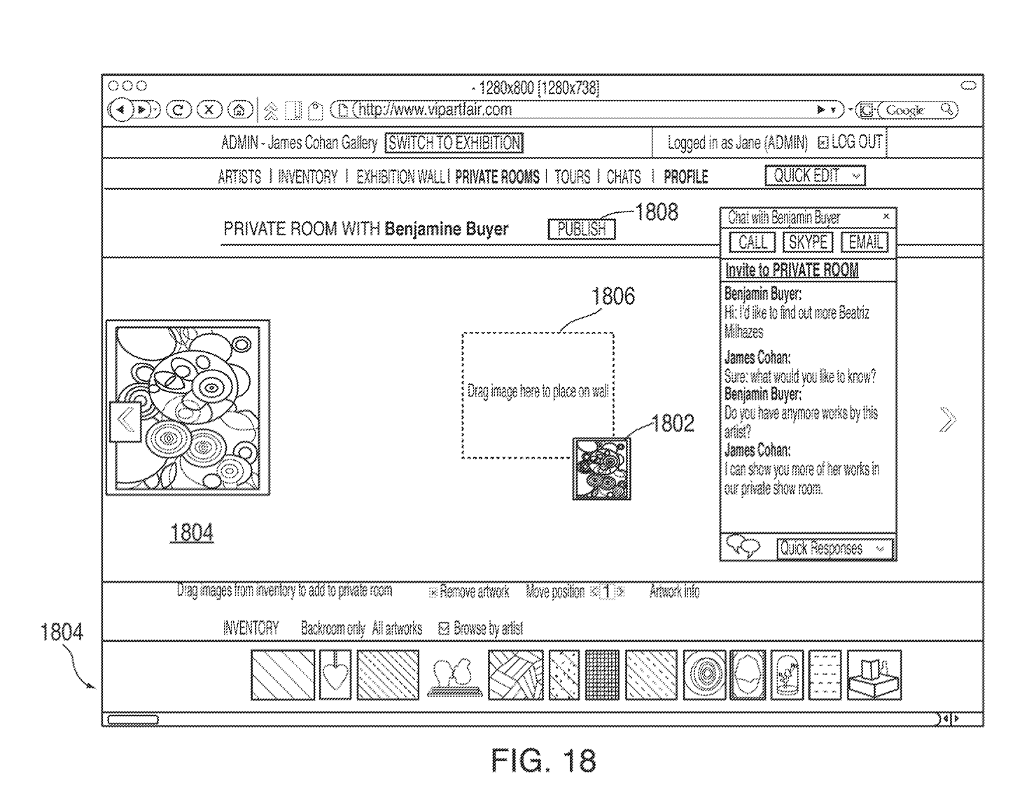

As illustrated in FIG. 18, a gallery owner or employee can configure a private room by dragging works of art 1802 from an artwork inventory (work library) 1804 to a spot 1806 on the private room wall. When the private room is ready to be viewed, the gallery owner or employee can publish the private room to the user using a publish button 1808. Alternatively, the artwork could be published as soon as it is dropped on the wall, or it could be published conditionally on an artwork-by-artwork basis. Just as in the public booth, artworks in the private room can be displayed to scale, and can be zoomed, multiple views can be shown, videos can be viewed, and advice notes and PDFs can be viewed and/or downloaded.

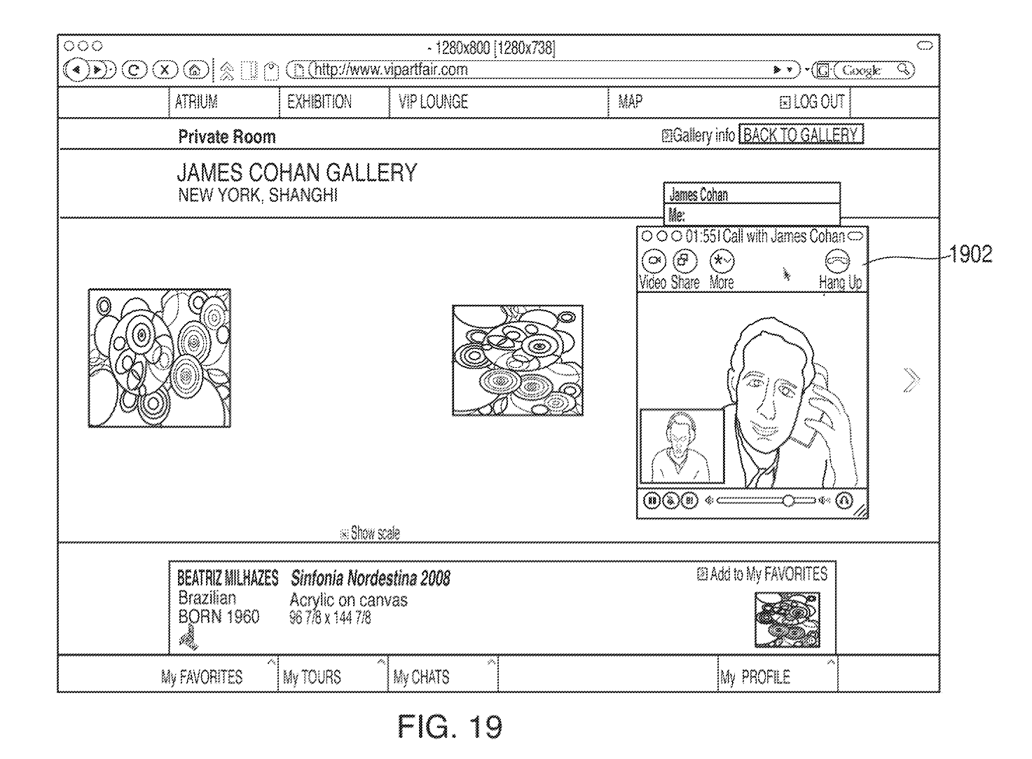

As illustrated in FIG. 19, a chat session can additionally or alternatively be conducted using other forms of communication such as video conferencing (as shown in conferencing window 1902), telephone, etc. The private room functionality can work in tandem with any of these means of communication.

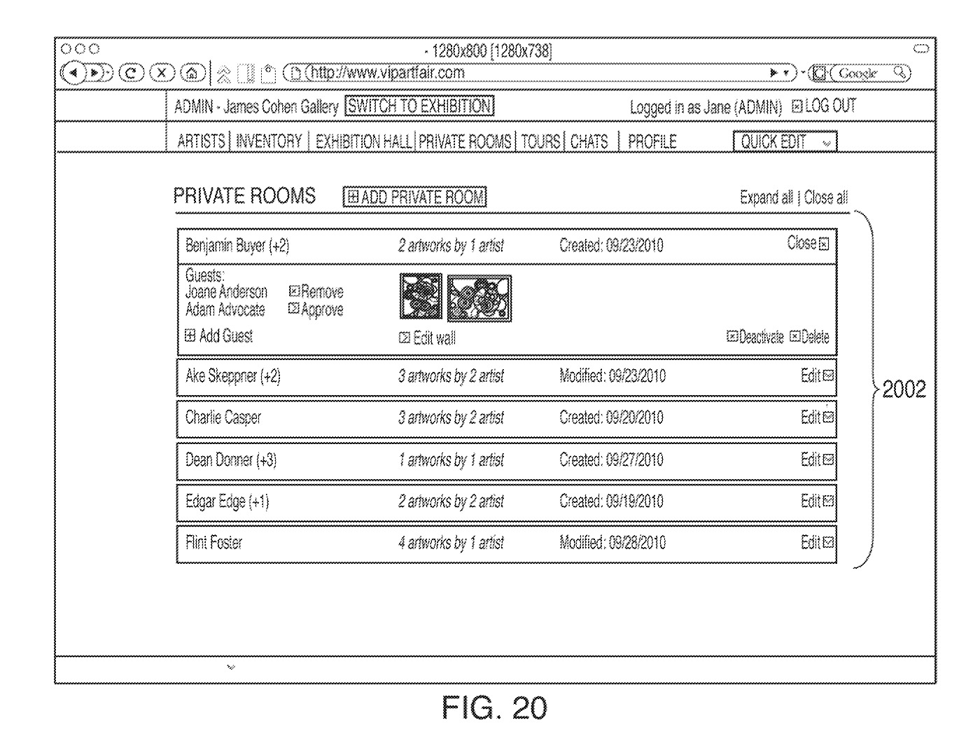

A list of private rooms 2002 that have been setup can be viewed by a booth administrator as shown in FIG. 20. As illustrated, this list can show the name of the user for whom the private room was configured, the name of guests to the private room, thumbnail images of works of art in the private room, the number of works in the private room, the number of artists represented in the private room, the date the private room was created, etc. The administrator can elect to close (deactivate) the private room and delete the private room in some embodiments.

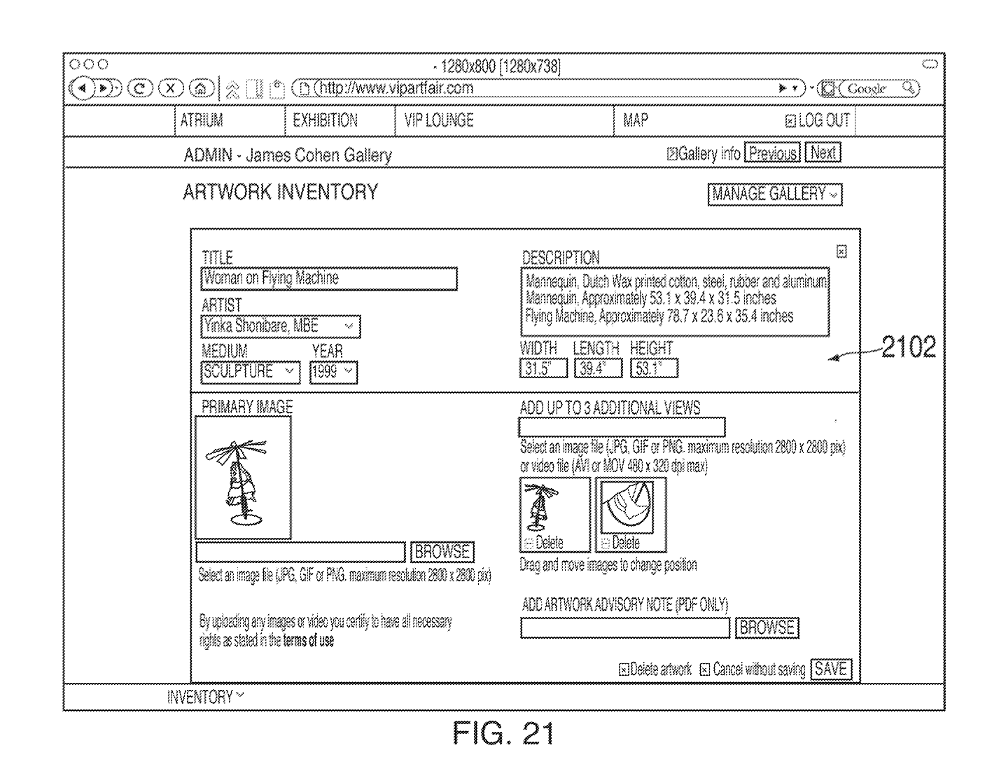

A booth administrator can use an artwork upload interface 2102 to upload works of art as shown in FIG. 21. As illustrated, the administrator can enter the title of a work, the artist of a work, the medium of a work, the year of a work, a primary image for a work, a description for a work, a size for a work, additional images for a work, an advisory note for a work, and any other suitable information or content:

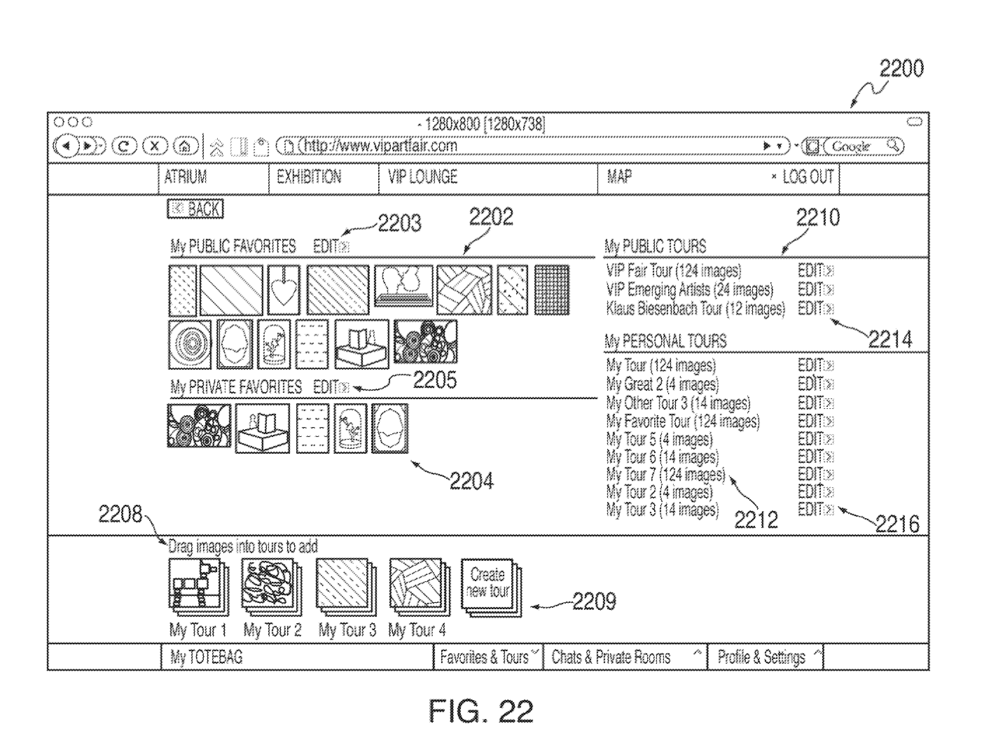

Turning to FIG. 22, an example of an interface 2200 for managing favorites and tours in accordance with some embodiments is illustrated. As shown, within this interface, a user may be presented with the user's public favorites 2202 and the user's private favorites 2204. These favorites may have been previously created by the user by clicking on an “add to my favorites” link corresponding to an artwork as illustrated in window 514 of FIG. 5. Public favorites may include artworks selected in publicly viewable areas of the virtual art fair (e.g., from gallery booths). Private favorites may include artworks selected in non-publicly viewable areas of the virtual art fair (e.g., from private rooms). In some embodiments, public favorites and/or private favorites may not be provided, and/or other forms of favorites may be provided. Public and/or private favorites may be edited using links 2203 and 2205, respectively.

In some embodiments, a user can use his/her favorites to create a tour. In some embodiments, only public favorites can be used to create a tour. A tour can be created by dragging one or more artworks from a favorites section 2202 or 2204 onto an existing tour 2208 or onto a create new tour icon 2209.

Public and personal tours 2210 and 2212 a user has taken can also be indicated in interface 2200. The user can select a tour and resume it, or restart it. Public tours 2210 may be tours that have been published in a lounge area (described below) and/or that can be seen by other users. In some embodiments, only certain users can share tours in the lounge area. Personal tours 2212 may be tours that have not been published in a lounge area, though a user may still be able to share them via email, social networking mechanisms, etc.

In some embodiments, a lounge may be provided. This lounge may include lists of the most-viewed works, gallery booths, artists, etc., statistics on the art fair, bulletin boards for exchanging information with other users, gallery owners and employees, and booth administrators, lists of tours that are available, videos created by gallery owners, gallery employees, artists, etc., news, information from social networking sites, etc.

In some embodiments, information about booths, such as the name, address, contact information, artworks viewed, chat interactions, private room information, etc. for each visitor to their booth, may be automatically logged and gallery owners and employees and booth administrators may have access to this information. In some embodiments, private rooms can be maintained for viewing and communication after a virtual art fair has ended. Email lists can also be automatically constructed for visitors to a booth in some embodiments.

In some embodiments, as works of art are sold during the art fair, those works may be automatically removed from a booth and substituted with other works. The other works may be selected to be similar in work type, price, etc. to a sold work, by the same artists as the sold work, or to have any other suitable characteristic.

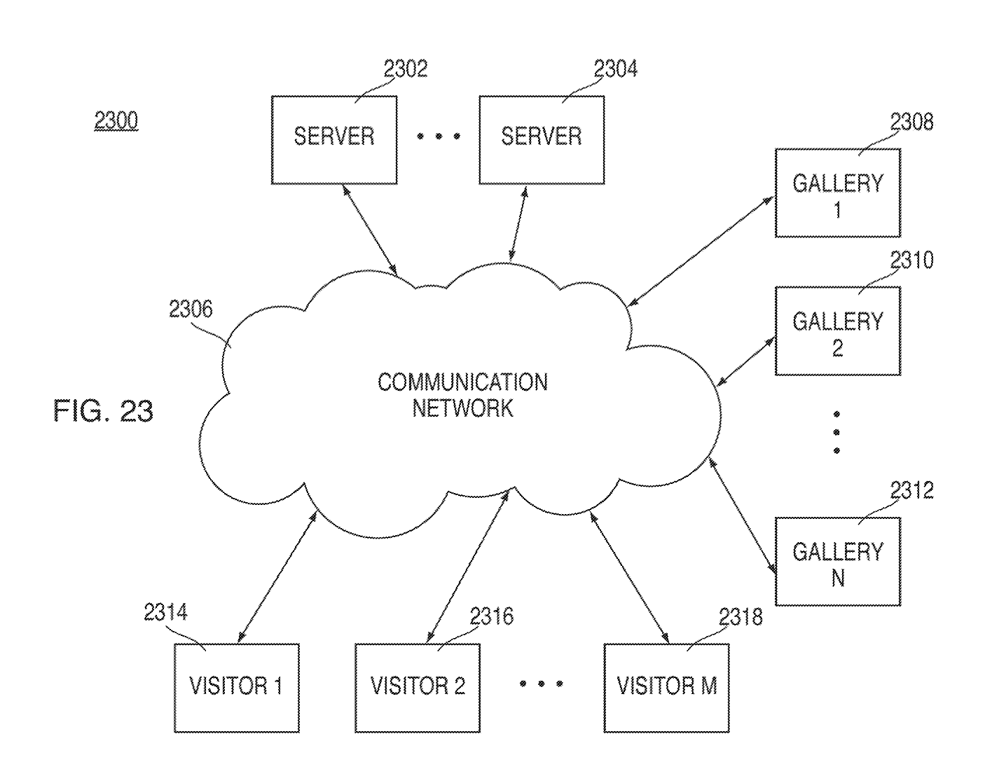

An example of hardware 2300 that can be used to implement some embodiments is shown in FIG. 23. As illustrated, hardware 2300 can include one or more servers 2302 and 2304. These servers may host software for providing the functionality described herein. The servers may also host data, media (e.g., image files, video files, etc.), etc. that are presented on in the virtual art fair. Hardware 2300 can also include one or more gallery devices 2308, 2310, and 2312 that can access the software, data, media, etc. on the servers via a communication network 2306. These gallery devices can be used to control a gallery's participation in the virtual art fair and enable the gallery owners and employees to participate in the virtual art fair as described above. The hardware can also include one or more visitor devices 2314, 2316, and 2318 that can access the software, data, media, etc. on the servers via a communication network 2306. The visitor devices can be used to enable visitors to participate in the virtual art fair as described above.

More particularly, for example, each of the one or more servers, gallery devices, and visitor devices can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, gallery and visitor devices can be implemented as a personal computer (such as a desktop, laptop, or tablet computer), a personal data assistant (PDA), a portable email device, a multimedia terminal, a mobile telephone, a smart phone, a set-top box, a television, an Internet appliance, a media player, etc.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. For example, while some embodiments have been described herein as being used to show and sell works of art, in accordance with some embodiments, any suitable good or service can be shown and sold using the mechanisms described herein. For example, in some embodiments, such mechanisms can be used to show and sell rare books, antiques, collectibles, etc. Features of the disclosed embodiments can be combined and rearranged in various ways.

What is claimed is:

1. A method for presenting works of art to a viewer, comprising:
receiving, at a hardware processor programmed to do so, a plurality of images that each represent a different one of a plurality of physical works of art;
receiving, at a hardware processor programmed to do so, size information for each of the plurality of physical works of art;
presenting an image representing a physical object on a display; and
presenting at least a portion of each of at least some of the plurality of images on the display with sizes scaled according to the relative sizes of the corresponding physical works of art compared to the size of the physical object.

2. The method of claim 1, wherein the physical object is a person.

3. The method of claim 1, further comprising receiving viewer information about at least one physical characteristic of the viewer, and wherein the size of the physical object is based on the viewer information.

4. The method of claim 1, wherein the physical object is a wall.

5. The method of claim 1, wherein the physical object is a work of art.

6. The method of claim 1, further comprising displaying artwork information describing at least one of the physical works of art.

7. The method of claim 1, further comprising controlling which of the plurality of images are presented based on viewer input.

8. A system for presenting works of art to a viewer, comprising:
at least one hardware processor that:
receives a plurality of images that each represent a different one of a plurality of physical works of art;
receiving size information for each of the plurality of physical works of art;
presents an image representing a physical object on a display; and
presents at least a portion of each of at least some of the plurality of images on the display with sizes scaled according to the relative sizes of the corresponding physical works of art compared to the size of the physical object.

9. The system of claim 8, wherein the physical object is a person.

10. The system of claim 8, wherein the at least one hardware processor also receives viewer information about at least one physical characteristic of the viewer, and wherein the size of the physical object is based on the viewer information.

11. The system of claim 8, wherein the physical object is a wall.

12. The system of claim 8, wherein the physical object is a work of art.

13. The system of claim 8, wherein the at least one hardware processor also displays artwork information describing at least one of the physical works of art.

14. The system of claim 8, wherein the at least one hardware processor also controls which of the plurality of images are presented based on viewer input.

15. A computer-readable medium containing computer-executable instructions that, when executed by a processor, cause the processor to perform a method for presenting works of art to a viewer, the method comprising:
receiving a plurality of images that each represent a different one of a plurality of physical works of art;
receiving size information for each of the plurality of physical works of art;
presenting an image representing a physical object; and
presenting at least a portion of each of at least some of the plurality of images with sizes scaled according to the relative sizes of the corresponding physical works of art compared to the size of the physical object.

16. The medium of claim 15, wherein the physical object is a person.

17. The medium of claim 15, wherein the method further comprises receiving viewer information about at least one physical characteristic of the viewer, and wherein the size of the physical object is based on the viewer information.

18. The medium of claim 15, wherein the physical object is a wall.

19. The medium of claim 15, wherein the physical object is a work of art.

20. The medium of claim 15, wherein the method further comprises displaying artwork information describing at least one of the physical works of art.

21. The medium of claim 15, wherein the method further comprises controlling which of the plurality of images are presented based on viewer input.
